(19) United States
(12) Patent Application Publication
(10) Pub. No.: US 2025/0286465 A1
(43) Pub. Date: Sep. 11, 2025

(54) MULTI-OUTPUT SWITCHING POWER SUPPLY AND CONTROL METHOD THEREOF

(71) Applicant: Joulwatt Technology Co., Ltd., Hangzhou (CN)

(72) Inventors: Xiangyong XU, Hangzhou (CN); Junming ZHANG, Hangzhou (CN)

(21) Appl. No.: 19/070,678

(22) Filed: Mar. 5, 2025

(30) Foreign Application Priority Data
Mar. 8, 2024 (CN) 202410268942.1
Dec. 5, 2024 (CN) 202411785069.X

(51) Int. Cl. H02M 3/335

(52) U.S. Cl. CPC H02M 3/33561; H02M 3/33592

(57) ABSTRACT

This application discloses a multi-output switching power supply and a control method thereof. The multi-output switching power supply comprises a power conversion circuit and plurality of output control transistors. The plurality of output control transistors are connected to the output terminal of the power conversion circuit. The power conversion circuit converts an input voltage into a first output voltage, and the plurality of output control transistors regulate the first output voltage into multiple voltage; the switching state of the main transistor in the power conversion circuit is controlled based on the feedback signal of an output terminal, and the switching state of plurality of output control transistors is controlled based on the output feedback signals of other output terminals. The plurality of output control solution of the present application does not require a two-stage power conversion circuit, and it has low cost, simple control, thus greatly improving system efficiency.

### CROSS-REFERENCE TO RELATED APPLICATIONS

This present disclosure claims priority to a Chinese patent application No. 2024102689421, filed on Mar. 8, 2024, and entitled “Multi-Output Switching Power Supply and Control Method thereof”, and a Chinese patent application No. 202411785069X, filed on Dec. 5, 2024, and entitled “Multi-Output Switching Power Supply and Control Method thereof”, the entire contents of which are incorporated herein by reference, including the specification, claims, drawings and abstract.

### FIELD OF TECHNOLOGY

The present disclosure relates to the field of switching power supply control technology, more particularly, to a multi-output switching power supply and a control method thereof.

### BACKGROUND

In multi-load application scenarios, a switching power supply needs to supply power to multiple loads, and here the switching power supply needs to output multiple different DC powers to different loads. Existing multi-output switching power supplies are usually designed with a two-stage power conversion scheme: a front-end power converter, e.g., a flyback converter, which converts high voltage power to low voltage power, and a post-end power converter, e.g., a buck converter, which converts the output voltage of the front-end power converter to the required power size. Generally, in order to meet the needs of multiple loads and system optimization, there is one front-end power converter and there are multiple post-end power converters.

As shown in FIG. 1, it is an existing multi-output solution, and the post-end power converter comprises two parallel buck converters, which respectively receive the output electrical power of the front-end power converter and convert it into different power output sizes for output. This multi-level scheme not only increases system costs but also reduces system efficiency.

Therefore, it is necessary to provide an improved technical solution to overcome the above technical problems in the prior art.

### SUMMARY OF THE DISCLOSURE

In view of this, the objective of the present disclosure is to provide a multi-output switching power supply and a control method thereof, to solve the technical problems of high cost and low efficiency of the multi-output switching power supplies in the prior art.

A multi-output switching power supply for providing a plurality of output power is provided, wherein the multi-output switching power supply comprises a power conversion circuit, plurality of output control transistors, a first control module, and a second control module; the power conversion circuit converts an input voltage of the multi-output switching power supply into a first output voltage, and the plurality of output control transistors are respectively connected to a plurality of output terminals of the power conversion circuit to regulate the first output voltage into a plurality of output voltages for output; obtains a first feedback signal based on the output feedback signal of a first output terminal in the plurality of output terminals and transmits it to the first control module to control the switching state of the main transistor in the power conversion circuit; obtains a second feedback signal based on the output feedback signals of other output terminals and transmits it to the second control module to control the switching state of the plurality of output control transistors.

Optionally, the power conversion circuit comprises a main transistor and plurality of freewheeling transistors; the plurality of freewheeling transistors and the plurality of output control transistors are connected one-to-one in the same power circuit.

Optionally, each freewheeling transistor is connected in series with the output control transistor in the same branch.

Optionally, the plurality of freewheeling transistors are either N-type or P-type transistors.

Optionally, the plurality of freewheeling transistors are freewheeling diodes.

Optionally, the power conversion circuit comprises a transformer; the main transistor is connected to the primary winding of the transformer, and the plurality of freewheeling transistors are connected to the secondary winding of the transformer, wherein, the plurality of freewheeling transistors are all connected to dotted end or undotted end of the secondary winding of the transformer.

Optionally, the multi-output switching power supply comprises two output terminals, and the plurality of output control transistors comprises two output control transistors; the two output control transistors respectively controls the output terminal voltage of the two output terminals; obtains the first feedback signal based on the output feedback signal of the first output terminal of output feedback in the two output terminals and transmits it to the first control module to control the switching state of the main transistor in the power conversion circuit; obtains the second feedback signal based on the output feedback signal of the second output terminal in the two output terminals and transmits it to the second control module to control the switching state of the two output control transistors.

Optionally, the switching states of the two output control transistors are complementary conduction.

Optionally, the first feedback signal is obtained by performing a preset weight calculation based on the output feedback signal of the first output terminal and the output feedback signal of the second output terminal; the second feedback signal is obtained by calculating the preset weight based on the output feedback signal of the second output terminal.

Optionally, the one with bigger output power in the two output terminals is taken as the first circuit, and the first feedback signal is obtained based on its output feedback signal; the one with smaller output power of the two output terminals is taken as the second output terminal, and the second feedback signal is obtained based on the its output feedback signal.

Optionally, the first control module comprises a first feedback unit, an isolation transmission unit, and a primary main control unit; the first feedback unit is connected to the output terminal of the first one of the two output terminals to obtain the first feedback signal; the isolation transmission unit isolates and transmits the first feedback signal to the primary control unit; the primary control unit generates a PWM control signal based on the signal transmitted by the isolation transmission unit to control the switching state of the main transistor.

Optionally, the second control module comprises a second feedback unit, a PWM control unit, and a switch driving module; the second feedback unit is connected to the output terminal of the second output terminal of the two output terminals to obtain the second feedback signal; the PWM control unit obtains a PWM control signal for controlling the duty cycle of the switch according to the second feedback signal; the switch driving module generates driving signals of the two output control transistors according to the PWM control signal.

Optionally, when the plurality of freewheeling transistors are N-type transistors or P-type transistors, the multi-output switching power supply further comprises a synchronous rectification control module; the synchronous rectification control module is used to provide the switching control signal of the freewheeling transistor to control the switching action of the freewheeling transistor; the synchronous rectification control module is connected to the second control module to adjust the switching state of the freewheeling transistor according to the switching control signal of the output control transistor.

Optionally, the synchronous rectification control module controls the freewheeling transistor of one of the two output terminals to turn off before the output control transistor of the other output terminal is turned on.

Optionally, the multi-output switching power supply comprises three output terminals, and the plurality of output control switch transistors comprises three output control switch transistor; the three output control switch transistor respectively controls the output terminal voltage of the three output terminals; the first feedback signal is obtained based on the output feedback signal of the first output terminal of the three output terminals and transmitted to the first control module to control the switching state of the main transistor in the power conversion circuit; the second control module comprises a first sub-second control module and a second sub-second control module; a second feedback signal is obtained based on the output feedback signal of the second output terminal of the three output terminals and transmitted to the first sub-second control module; a third feedback signal is obtained based on the output feedback signal of the third output of the three output terminals and transmitted to the second sub-second control module; the first sub-second control module and the second sub-second control module control the switching state of the three output control transistors through logical operations.

Optionally, the sum of duty cycles of the three output control transistors is 1.

In the second aspect, a control method for a multi-output switching power supply is provided, the multi-output switching power supply comprising a power conversion circuit and a plurality of output control transistors, wherein comprising the following steps:
the power conversion circuit converts the input voltage of the multi-output switching power supply into a first output voltage, and the plurality of output control transistors are respectively connected to a plurality of output terminals of the power conversion circuit to regulate the first output voltage to plurality of different output voltages for output; obtaining a first feedback signal based on the output feedback signal of the first output terminal in the plurality of output terminals to control the switching state of the main transistor in the power conversion circuit; obtaining a second feedback signal based on the output feedback signals of other output terminals in the plurality of output terminals to control the switching state of the plurality of output control transistors.

Optionally, the multi-output switching power supply comprises two output terminals, and the plurality of output control transistors comprises two output control transistors, performing a preset weight calculation based on the output feedback signal of the first output terminal and the output feedback signal of the second output terminal to obtain the first feedback signal; performing a preset weight calculation based on the output feedback signal of the second output terminal to obtain the second feedback signal.

Optionally, the multi-output switching power supply comprises two output terminals, and the plurality of output control transistors comprises two output control transistors, and performing a preset weight calculation based on the output feedback signal of the first output terminal and the output feedback signal of the second output terminal to obtain the first feedback signal; performing a preset weight calculation based on the output feedback signal of the second output terminal to obtain the second feedback signal.

Optionally, the sum of the duty cycles of the two output control transistors is 1.

Optionally, the multi-output switching power supply comprises three output terminals, and the plurality of output control transistors comprises three output control transistors, and the three output control transistors respectively controls the output terminal voltage of the three output terminals; obtains a first feedback signal based on the output feedback signal of the first output terminal of the three output terminals to control the switching state of the main transistor in the power conversion circuit; the second control module controls the switching state of the three output control transistors based on the output feedback signal of the second output terminal and the output feedback signal of the third output terminal in the three output terminals; wherein, the sum of the duty cycles of the three output terminals output control transistor is 1.

In the multi-output switching power supply and the control method thereof of the present application, the multi-output switching power supply comprises a power conversion circuit and plurality of output control transistors, wherein the plurality of output control transistors are connected to the output terminal of the power conversion circuit, the power conversion circuit converts the input voltage into a first output voltage, and the plurality of output control transistors regulate the first output voltage to multiple different voltage for output; an output feedback signal of one output terminal the output terminals is transmitted to the first control module as the first feedback signal to control the switching state of the main transistor in the first stage power conversion circuit. The output feedback signals of the other output terminals are transmitted to the second control module as the second feedback signal to control the switching state of the plurality of output control transistors. The plurality of output control solution of the present application does not require two stage power conversion circuits, and it has low cost, easy to control, thus greatly improving system efficiency.

### BRIEF DESCRIPTION OF THE DRAWINGS

FIG. 1 is a circuit block diagram of the prior art multi-output switching power supply;

FIG. 2 is a circuit block diagram of the first embodiment of the multi-output switching power supply of the present disclosure;

FIG. 3 is an implementing circuit diagram of the second control module in FIG. 2 of the present disclosure;

FIG. 4 is a working waveform of the circuit in FIG. 2;

FIG. 5 is a circuit block diagram of the second embodiment of the multi-output switching power supply of the present disclosure;

FIG. 6 is an implementing circuit diagram of the synchronous rectification control module in FIG. 5;

FIG. 7 is an implementing circuit diagram of the second control module in FIG. 5 of the present disclosure;

FIG. 8 is a first working waveform of the circuit in FIG. 5;

FIG. 9 is a second working waveform of the circuit in FIG. 5;

FIG. 10 is a circuit block diagram of the third embodiment of the multi-output switching power supply in the present disclosure;

FIG. 11 is an implementing circuit diagram of the second control module in FIG. 5 of the present disclosure;

FIG. 12 is a circuit diagram of the fourth embodiment of the multi-output switching power supply of the present disclosure;

FIG. 13 is a circuit diagram of the fourth embodiment of the multi-output switching power supply of the present disclosure.

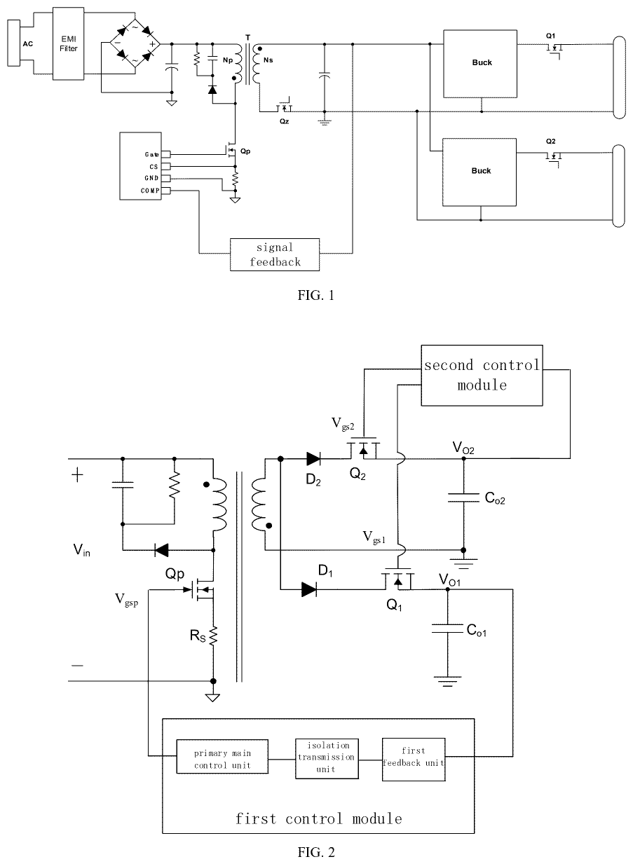

### DETAILED DESCRIPTION OF THE DISCLOSURE

The following will describe the preferred embodiments of the present disclosure in great details by combining with the accompanying drawings. However, the present disclosure is not restricted to these embodiments. The present disclosure convers any replacement, modifications, equivalent methods, and solutions made within the sprits and scope of the present disclosure.

In order to make the public have a thorough understanding, specific details are described in the following preferred embodiments of the present disclosure; however, those skilled in the art can totally understand the present disclosure without these detailed descriptions.

The present disclosure is described in great details in the following paragraphs by referring to the accompanying drawings. It should be noted that the accompanying drawings all use simplified forms and use non-accurate sales, just for the purpose of conveniently and clearly illustrate the embodiments of the present disclosure.

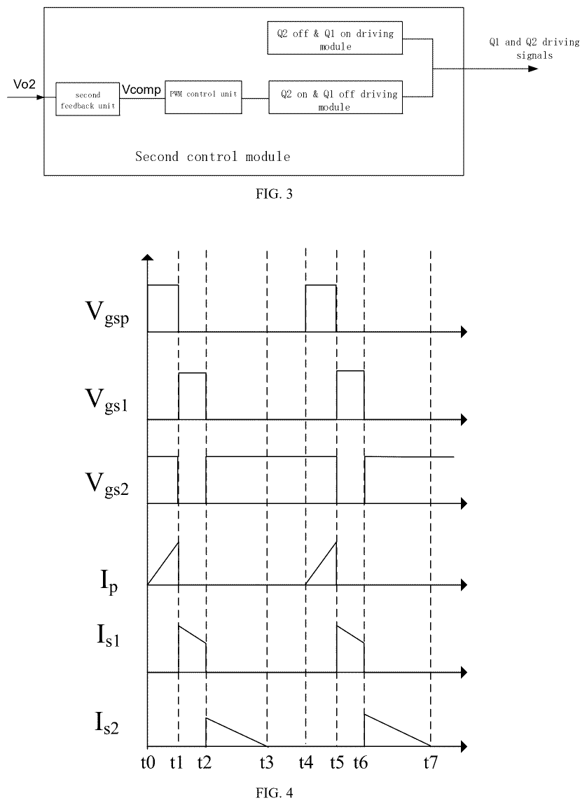

Refer to FIG. 2, it is a circuit diagram of a first embodiment of the multi-output switching power supply according to the present disclosure. In this embodiment, two-output switching power is taken as an example. FIG. 3 is an implementation circuit diagram of the second control module in FIG. 2 of the present disclosure; FIG. 4 is a working waveform of the circuit of FIG. 2. The multi-output switching power supply in this embodiment comprises a power conversion circuit, two output control transistors (e.g., transistor Q1 and transistor Q2), a first control module, and a second control module. The power conversion circuit converts the input voltage of the multi-output switching power supply into a first output voltage, and the two output control transistors are respectively connected to the two output terminals of the power conversion circuit to regulate the first output voltage to two output voltages for output. Here, the two output voltages can be of the same voltage value or different voltage values. Refer to FIG. 2, here, the power conversion circuit takes the flyback switching topology as an example, which comprises a main transistor Qp and two freewheeling transistors, such as diode D1 and diode D2. The two freewheeling transistors are connected with the two output control transistors in a one-to-one manner in the same power circuit, and here it is connected to power circuit at the output side. Here, each freewheeling transistor is connected in series with the output control transistor on the same branch of the power circuit, which can prevent energy backflow when the output voltages of multi-output switching power are not equal or differ greatly. The flyback switching topology further comprises a transformer, and the main transistor is connected to the primary winding of the transformer, and the plurality of freewheeling transistors are connected to the secondary winding of the transformer, wherein the plurality of freewheeling transistors are all connected to the dotted end or undotted end of the secondary winding of the transformer. FIG. 2 takes that the freewheeling transistors are all connected to undotted end as an example.

Specifically, refer to FIGS. 2 and 3, the first control module comprises a first feedback unit, an isolation transmission unit, and a primary control unit. The first feedback unit is connected to the first output terminal of the two output terminals to obtain the first feedback signal, and the isolation transmission unit isolates and transmits the first feedback signal to the primary control unit; the primary control unit generates a PWM control signal based on the signal transmitted by the isolation transmission unit to control the switching state of the main transistor. The isolation transmission unit here can be an optocoupler device, which couples the first feedback signal to the primary receiver. The receiver transmits the signal to the primary control unit, which generally comprises a primary PWM control signal generator and a switching driver. It controls the switching action of the main transistor Qp according to the feedback signal to regulate the output voltage of the power conversion circuit. The first feedback unit can be a sampling circuit composed of resistors, and the primary control unit can be a control and driving unit in the prior art.

Refer to FIG. 3, the second control module comprises a second feedback unit, a PWM control unit, and a switching drive module. The second feedback unit is connected to the second output terminal of the two output terminals to obtain the second feedback signal, e.g., the error compensation signal Vcomp, which is obtained by performing error amplification compensation processing on the output signal and the reference signal; the PWM control unit obtains a PWM control signal that controls the switch duty cycle based on the second feedback signal comp. The switching drive module generates driving signals of the two output control transistors based on the PWM control signal. Here the switching drive module comprises a Q2 on & Q1 off drive module and a Q2 off & Q1 on drive module. By driving the transistors Q1 and Q2, it is preferable to make the switching states of the two output control transistors Q1 and Q2 complementary to each other for control convenience, and the sum of the duty cycles is 1.

Refer to FIG. 4, it is a working waveform of FIG. 2; at time t1, the switching control signal Vgsp of the main power transistor is low, and the main power transistor is turned off, the switching control signal Vgs1 of Q1 becomes high, and the transistor Q1 is turned on; the switching control signal Vgs2 of Q2 is low, and Q2 is turned off; the first output power circuit is turned on, and Is1 decreases; at time t2, switch transistor Q1 is turned off, Q2 is turned on, Is2 continues to decrease, and the second output power circuit is turned on; afterwards, at time t3, the current of the second output power circuit drops to zero. At time t4, the primary main power transistor is turned on again, and the excitation inductance current Ip increases. At time t5, the first output power circuit is turned on and the second output power circuit is turned off, and so on. Optionally, in the direct interval from t3 to t5, Q2 can be turned off and Q1 can be turned on, and the control effect is not affected. Those skilled in the art know that during the switching process of transistors Q1 and Q2, an overlapping conduction time interval of the two transistors can be set to ensure the smooth path of excitation current.

From the above embodiments, the two-output switching power supply of the present disclosure does not require a two-stage circuit. By controlling the transistor Q1 and Q2, and based on the feedback signals, the switching power supply can achieve separate control of the voltage of two output terminals in a circuit with simple control.

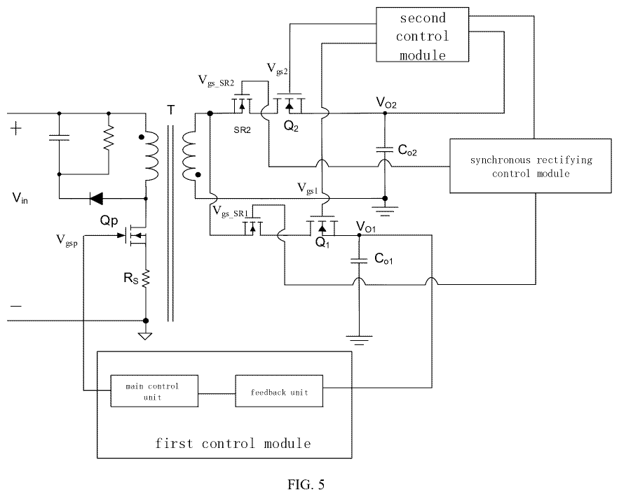

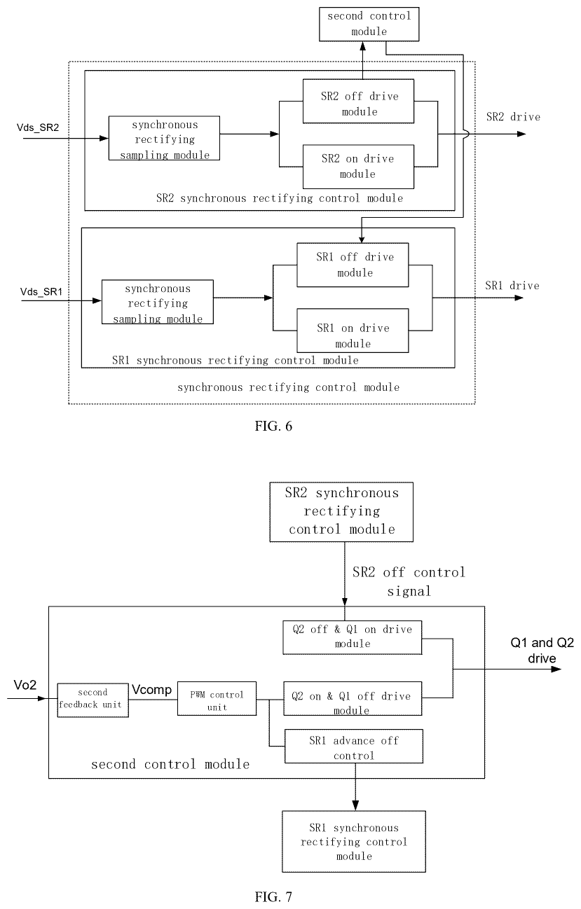

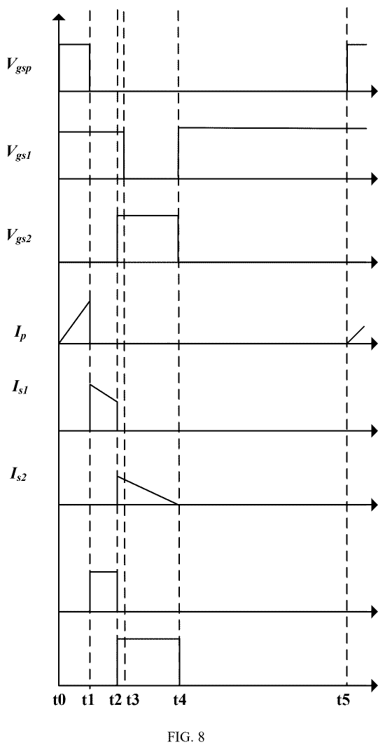

Refer to FIG. 5, it is a circuit diagram of the second embodiment of the multi-output switching power supply according to the present disclosure. In this embodiment, the freewheeling transistor is a synchronous rectifying transistor. In this embodiment, the synchronous rectifying transistor and the output control transistor are connected in series, and both are connected to the high side of the output power circuit and in the same branch. Of course, the two can also be connected in series to the low side of the output power circuit. FIG. 6 shows an implementation circuit diagram of the synchronous rectifying control module in FIG. 5, which is used to drive the synchronous rectifying transistor. FIG. 7 shows an implementation circuit diagram of the second control module in FIG. 5 of the present disclosure. As shown in FIG. 6, the synchronous rectifying control module is used to provide the switching control signal of the freewheeling transistor to control the switching action of the freewheeling transistor; the synchronous rectifying control module is connected to the second control module to regulate the switching state of the freewheeling transistor according to the switching control signal of the output control transistor. The synchronous rectifying control module comprises a first SR1 synchronous rectifying control module and a second SR2 synchronous rectifying control module. The SR1 synchronous rectifying control module includes a synchronous rectifying sampling module that samples the drain source voltage of the SR2 transistor; the SR2 on and off drive modules turn on and off SR2 based on the sampled signal. At the same time, the SR2 off drive module transmits the signal to turn off SR2 to the second control module. The structure of the SR2 synchronous rectifying control module is the same as that of the SR1 synchronous rectifying control module, and they differ in that SR2 off drive module receives the signal transmitted by the second control module SR1.Both the synchronous rectifying control module and the SR2 synchronous rectifying control module can be used as control and driving solutions for synchronous rectifying transistors in the current technology. For example, the drain source voltage flowing through the SR is compared with the threshold voltage to turn on the SR, and the current and drain source voltage of the SR are detected and compared with the threshold voltage to turn off the SR.

FIG. 7 shows an implementation circuit diagram of the second control module in FIG. 5 of the present disclosure. The structure of the second control module is generally the same as that of the second control module in FIG. 3, except that the Q2 off and Q1 on driving module receive the control signal to turn off R2 transmitted by the SR2 synchronous rectifying control module to control the switching action of Q2 and Q1 according to their off timing. In addition, before SR2 is turned on, the SR1 advance off control signal shown in FIG. 5 is transmitted to the SR1 synchronous rectifying module to control SR1 to turn off in advance.

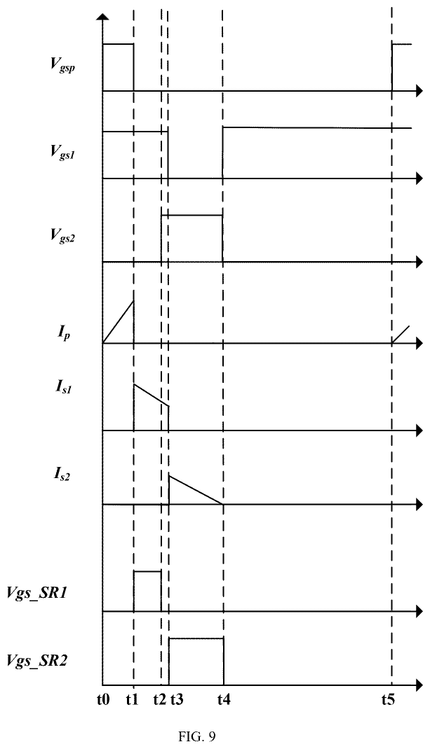

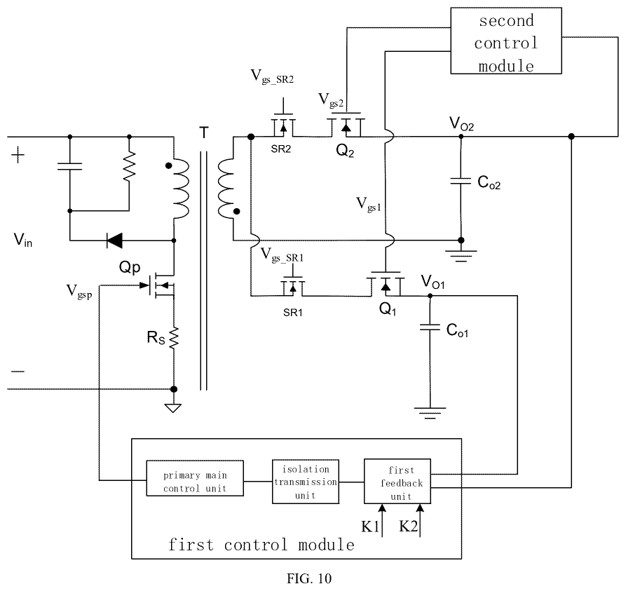

For the circuit diagram in FIG. 5, in the case where the voltage of two output terminals is unequal or even different significantly, when transistor Q1 continues to turn on, transistor Q2 begins to turn on. At this time, since SR synchronous rectification can flow current bidirectionally, there will be a large discharge current from Vo1 output capacitor to Vo2 output capacitor, or a large discharge current from Vo2 output capacitor to Vo1 output capacitor. Therefore, Optionally, the synchronous rectifying control module controls one of the two power circuits to turn off the freewheeling transistor before the output control transistor of the other power circuit turns on. As shown in FIG. 5, the SR1 transmits the control signal in advance to the SR1 synchronous rectifying module, so that the freewheeling transistor can be turned off. FIG. 8 shows the first working waveform of the circuit in FIG. 5. If the output voltage of the second output power circuit is greater than that of the first output power circuit, the drive of the SR1 synchronous rectifier transistor is forcibly turned off at or before transistor Q2 is turned on. This can prevent a large discharge current between the two output power circuits during the driving overlap stage of Q1 and Q2, such as the overlapping interval between t2 and t3 in FIG. 8; refer to FIG. 9, it is a second working waveform of the circuit in FIG. 5; for example, the voltage of the first output terminal is greater than that of the second output terminal, the driving of the SR1 synchronous rectifier transistor is forcibly turned off at or before when the transistor Q2 is turned on. Unlike FIG. 8, Q2 is turned on at time t2, but since the voltage Vo2 of the second output terminal is higher than the voltage Vo1 of the first output terminal, the excitation current needs to wait until Q1 is turned off before flowing to the output terminal of Vo2, e.g., time t3. The reference signs in FIGS. 8 and 9 are the same as those in FIG. 4, and can be understood in the same way. Vgs_SR1 is the switching control signal for SR1, and Vgs_SR2 is the switching control signal for SR2, both of which are provided by the synchronous rectifying control module.

Optionally, the freewheeling transistor in FIG. 5 is taken as an example of an N-type transistor, which can also be a P-type transistor. When the freewheeling transistor is a P-type transistor, the P-type transistor can be connected to the low potential terminal of the secondary edge output circuit, such that the driving of the P-type transistor is simpler.

Refer to FIG. 10, it is a circuit diagram of a third embodiment of a multi-output switching power supply according to the present disclosure. The circuit architecture of this embodiment is the same as that of the embodiment shown in FIG. 5. The difference is that in this embodiment, the first feedback unit calculates the preset weight based on the output feedback signal of the first output terminal and the output feedback signal of the second output terminal to obtain the first feedback signal. For example, the first feedback unit receives the output feedback signal Vo1 of the first output terminal and the output feedback signal Vo2 of the second output terminal, as well as the reception coefficients K1 and K2, and calculates the weights of the two signals as follows: Vo1*k1+Vo2*k2=Vref1, and obtains feedback signal Vref1 as the first feedback signal and transmits it to the isolation transmission unit; similarly, the second feedback unit receives the output feedback signal Vo2 and coefficient K3 from the second output terminal, and performs weight calculation as follows: Vo1*k3=Vref2; the feedback signal Vref2 is transmitted as the second feedback signal to the PWM control unit. Refer to FIG. 5, it is an implementation circuit diagram of the first control module; refer to FIG. 11, it is an implementation circuit diagram of the second control module in FIG. 5 according to the present disclosure; the first feedback unit and the second feedback unit are added with coefficients, which can be set internally or externally and transmitted to the feedback unit. The above k1, k2, and k3 are set according to the system requirements and load conditions, which can accurately feedback the signal amplitude, thereby controlling the output voltage Vo1 and Vo2 more accurately. This embodiment is more accurate and reliable for feedback and controlling the output voltage, and can also ensure that the output voltage or output power are satisfied in any situation.

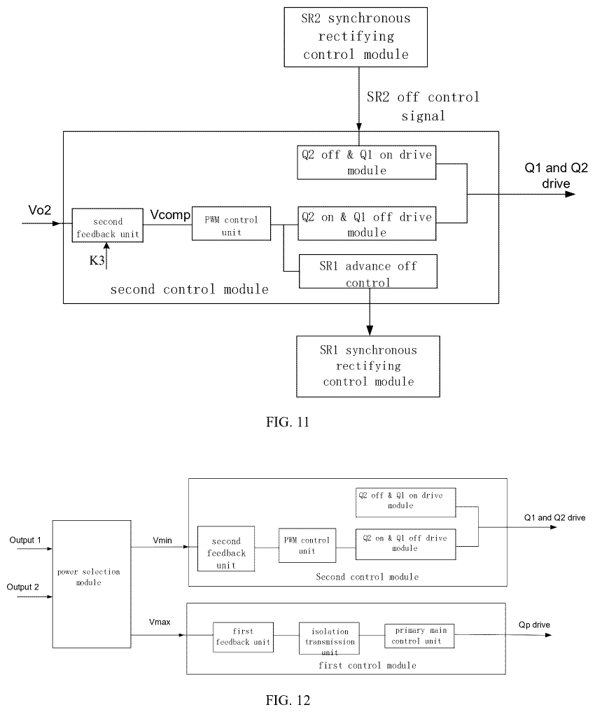

Refer to FIG. 12, it is a circuit diagram of a fourth embodiment of the multi-output switching power supply according to the present disclosure. The circuit architecture of this embodiment is the same as that of the embodiment shown in FIG. 5, but they differ in that the first feedback signal is obtained based on the output feedback signal of the one with higher output power in the two output terminals; based on the smaller output power of the two output terminals, take the second output terminal and obtain the second feedback signal based on its output feedback signal. In some cases, due to the different sizes of the two loads or the presence of no-load on one of them, selecting the high-power feedback signal as the feedback signal to control the main transistor can ensure that the output power supply of the normal load is not affected under no-load condition. As shown in FIG. 12, the multi-output switching power supply comprises a power selection module. Based on the output voltage or output power of two output terminals, Output1 and Output2, the output terminal with higher power is selected to transmit to the first feedback unit, and the output terminal with lower power is transmitted to the second feedback unit. This allows the switching control of the main power transistor to meet the requirements of the output terminal with higher power.

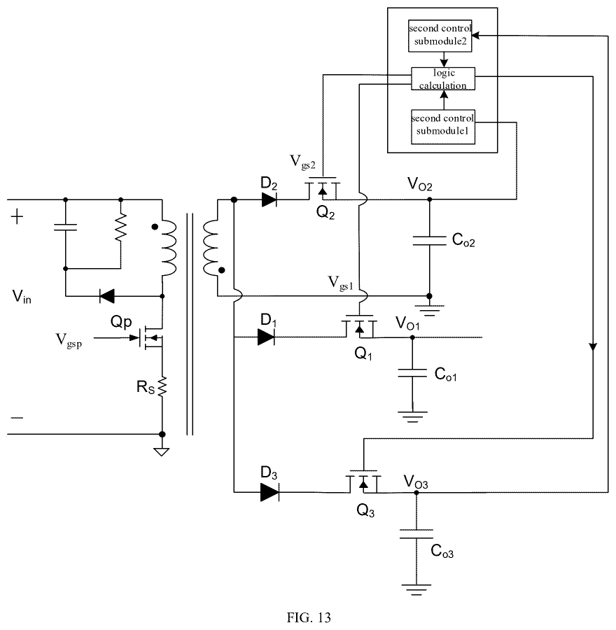

FIG. 13 is a circuit diagram of the fourth embodiment of the multi-output switching power supply according to the present disclosure. The multi-output switching power supply comprises three output terminals, and the plurality of output control transistors comprises three output control transistors, which respectively controls the voltage of the three output terminal; obtain the first feedback signal based on the output feedback signal of the first output terminal of the three output terminals and transmit it to the first control module to control the switching state of the main transistor in the power conversion circuit; the second control module comprises a second control submodule 1 (first sub-second control module) and a second control submodule 2 (second sub-second control module). The second feedback signal is obtained based on the output feedback signal of the second output terminal of the three output terminals and transmitted to the second control module 1. The third feedback signal is obtained based on the output feedback signal of the third output terminal of the three output terminals and transmitted to the second control module 2; the second control module 1 and the second control module 2 control the switching state of the three output control transistors through logical operation module. The sum of the duty cycles of the three output control transistors is 1. Here, both the second control submodule 1 and the second control submodule 2 can have the same or similar structure as the second control module in FIG. 3.

In the case of three output terminals, the first control module can be the same as any embodiment of the circuit in FIGS. 2, 5, 10, and 11, except that the feedback signal changes from two to three, such as two weighted operations changing to three weighted operations, or selecting the one with the highest power among the three output terminals to offer the feedback signal.

Those skilled in the art know that, inspired by the embodiments of the present disclosure, the multi-output switching power supply can also be multiple output terminals like four or five output terminals, and its control concept is the same as or similar to that of the present disclosure, all of which are within the protection scope of the present disclosure.

Finally, the present application provides a control method for a switching power supply, wherein the multi-output switching power supply comprises a power conversion circuit and a plurality of output control transistors, comprising the following steps: the power conversion circuit converts the input voltage of the multi-output switching power supply into a first output voltage, and the plurality of output control transistors is respectively connected to a plurality of output terminals of the power conversion circuit to regulate the first output voltage to a plurality of output voltages;

It obtains the first feedback signal based on the output feedback signal of the first output terminal in the plurality of output terminals to control the switching state of the main transistor in the power conversion circuit;

It obtain a second feedback signal based on the output feedback signals of other output terminals in the plurality of output terminals to control the switching state of the plurality of output control switch transistors.

Optionally, the multi-output switching power supply comprises two output terminals, and the plurality of output control transistors comprises two output control transistors, and obtains the first feedback signal by performing a preset weight calculation based on the output feedback signal of the first output terminal and the output feedback signal of the second output terminal; and calculates the preset weight based on the output feedback signal of the second output terminal to obtain the second feedback signal.

Optionally, the multi-output switching power supply comprises two output terminals, and the plurality of output control transistors comprise two output control transistors. The first feedback signal is obtained based on the output feedback signal of the one with higher output power of the two output terminals; according to the smaller output power of the two output terminals, take the second output terminal and obtain the second feedback signal according to its output feedback signal.

Optionally, the sum of the duty cycles of the two output control transistors is 1.

Optionally, the plurality of output control transistors comprises three output control transistors, each of which controls the voltage of the three output terminal; obtains the first feedback signal based on the output feedback signal of the first output terminal of the three output terminals to control the switching state of the main transistor in the power conversion circuit; the second control module controls the switching state of the three output control transistors based on the feedback signals from the second and third output terminal, where the sum of the duty cycles of the three output control switch transistors is 1.

It should be noted that the modules and units involved in this application are realized by circuit structures and do not refer to software programs. It is also to be noted that “a plurality of output control transistors are respectively connected to a plurality of output terminals of the power conversion circuit” means “the multi-output switching power supply comprising multiple output circuits with one output control transistor in each output circuit”. “Output feedback signal of an output terminal” defined in this application means “output feedback signal of an output circuit”, and does not define that the output feedback signal is obtained directly from the output terminal. As is known by common knowledge in the art, the output feedback signal may be obtained directly from the output terminal or may be obtained through an auxiliary winding.

It should be supplemented that the provided specific implementation and corresponding drawings are only one way to describe the implementation method of the present disclosure, rather than restricting the specific structure of the implementation scheme of the present disclosure. Various changes or modifications can be made to these implementation schemes without departing from the principles and essence of the present disclosure, but all these changes and modifications fall within the protection scope of the present disclosure.

Although the above embodiments have been explained and elaborated separately, some common technologies involved can be replaced and integrated among the embodiments in the eyes of those of ordinary skill in the art. If there is any content that is not clearly recorded in one embodiment, reference can be made to the other recorded embodiment.

The above implementation methods do not constitute restriction on the protection scope of the technical solution. Any modifications, equivalent replacement, and improvements made within the spirit and principles of the above implementation shall be included within the protection scope of the technical solution.

What is claimed is:

1. A multi-output switching power supply for providing a plurality of output power, wherein the multi-output switching power supply comprises a power conversion circuit, a plurality of output control transistors, a first control module, and a second control module,
the power conversion circuit converts an input voltage of the multi-output switching power supply into a first output voltage, and the plurality of output control transistors are respectively connected to a plurality of output terminals of the power conversion circuit to regulate the first output voltage into a plurality of output voltages;
a first feedback signal is obtained according to an output feedback signal of a first output terminal in a plurality of output terminals, and is transmitted to the first control module to control a switching state of the main transistor in the power conversion circuit;
a second feedback signal is obtained according to output feedback signals of other output terminals, and is transmitted to the second control module to control switching states of the plurality of output control transistors.

2. The multi-output switching power supply of claim 1, wherein the power conversion circuit comprises a main transistor and a plurality of freewheeling transistors,
the plurality of freewheeling transistors and the plurality of output control transistors are connected one-to-one in a power circuit.

3. The multi-output switching power supply of claim 2, wherein each freewheeling transistor is connected in series with the output control transistor in a same branch of the power circuit.

4. The multi-output switching power supply of claim 2, wherein the plurality of freewheeling transistors are N-type transistors or P-type transistors, and/or the plurality of freewheeling transistors are freewheeling diodes.

5. The multi-output switching power supply of claim 4, wherein the power conversion circuit comprises a transformer,
the main transistor is connected to a primary winding of the transformer, and the plurality of freewheeling transistors are connected to a secondary winding of the transformer,
wherein, the plurality of freewheeling transistors are all connected to a dotted end or undotted end of the secondary winding of the transformer.

6. The multi-output switching power supply of claim 1, wherein the multi-output switching power supply comprises two output terminals, and the plurality of output control transistors comprises two output control transistors,
the two output control transistors respectively control the voltage of the two output terminals;
the first feedback signal is obtained according to the output feedback signal of the first output terminal in the two output terminals, and is transmitted to the first control module to control the switching state of the main transistor in the power conversion circuit;
the second feedback signal is obtained according to the output feedback signal of the second output terminal, and is transmitted to the second control module to control the switching states of the two output control transistors.

7. The multi-output switching power supply of claim 6, wherein the switching states of the two output control transistors are complementary conduction.

8. The multi-output switching power supply of claim 6, wherein the first feedback signal is obtained by performing a preset weight calculation based on the output feedback signal of the first output terminal and the output feedback signal of the second output terminal;
the second feedback signal is obtained by performing the preset weight calculation based on the output feedback signal of the second output terminal.

9. The multi-output switching power supply of claim 6, wherein the one with bigger output power in the two output terminals serves as the first output terminal;
the one with smaller output power of the two output terminals serves as the second output terminal.

10. The multi-output switching power supply of claim 6, wherein the first control module comprises a first feedback unit, an isolation transmission unit, and a primary main control unit,
the first feedback unit is connected to the first output terminal to obtain the first feedback signal;
the isolation transmission unit isolates and transmits the first feedback signal to the primary control unit;
the primary control unit generates a PWM control signal based on the signal transmitted by the isolation transmission unit to control the switching state of the main transistor.

11. The multi-output switching power supply of claim 6, wherein the second control module comprises a second feedback unit, a PWM control unit, and a switching drive module,
the second feedback unit is connected to the second output terminal to obtain the second feedback signal;
the PWM control unit obtains a PWM control signal for controlling the duty cycle according to the second feedback signal,
the switching drive module generates driving signals of the two output control transistors according to the PWM control signal.

12. The multi-output switching power supply of claim 2, wherein the plurality of freewheeling transistors are N-type transistors or P-type transistors, the multi-output switching power supply further comprises a synchronous rectification control module,
the synchronous rectification control module is used to provide a switching control signal of the freewheeling transistor to control the switching state of the freewheeling transistor;
the synchronous rectification control module is connected to the second control module to adjust the switching state of the freewheeling transistor according to the switching control signal of the output control transistor.

13. The multi-output switching power supply of claim 12, wherein the power conversion circuit comprises two freewheeling transistors, and the plurality of output control transistors comprises two output control transistors, the synchronous rectification control module controls the freewheeling transistor of one power circuit to be off before the output control transistor of the other power circuit is turned on.

14. The multi-output switching power supply of claim 1, wherein the multi-output switching power supply comprises three output terminals, and the plurality of output control transistors comprises three output control transistors,
the three output control transistors respectively control the voltage of the three output terminals;
the first feedback signal is obtained based on the output feedback signal of the first output terminal of the three output terminals, and is transmitted to the first control module to control the switching state of the main transistor in the power conversion circuit;
the second control module comprises a first sub-second control module and a second sub-second control module; the second feedback signal is obtained based on the output feedback signal of the second output terminal, and is transmitted to the first sub-second control module; a third feedback signal is obtained based on the output feedback signal of the third output terminal and transmitted to the second sub-second control module; the first sub-second control module and the second sub-second control module control the switching state of the three output control transistors through a logical operation.

15. The multi-output switching power supply of claim 14, wherein a sum of duty cycles of the three output control transistors is 1.

16. A control method for a multi-output switching power supply, the multi-output switching power supply comprising a power conversion circuit and a plurality of output control transistors, wherein the control method comprises:
converting an input voltage of the multi-output switching power supply into a first output voltage by the power conversion circuit, the plurality of output control transistors being respectively connected to a plurality of output terminals of the power conversion circuit to regulate the first output voltage to a plurality of output voltages;
obtaining a first feedback signal based on an output feedback signal of a first output terminal in a plurality of output terminals to control a switching state of a main transistor in the power conversion circuit;
obtaining a second feedback signal based on output feedback signals of other output terminals to control switching states of the plurality of output control transistors.

17. The control method for the multi-output switching power supply of claim 16, wherein the multi-output switching power supply comprises two output terminals, and the plurality of output control transistors comprise two output control transistors,
performing a preset weight calculation based on the output feedback signal of the first output terminal and the output feedback signal of the second output terminal to obtain the first feedback signal;
performing a preset weight calculation based on the output feedback signal of the second output terminal to obtain the second feedback signal.

18. The control method for the multi-output switching power supply of claim 16, wherein the multi-output switching power supply comprises two output terminals, and the plurality of output control transistors comprise two output control transistors,
obtaining a first feedback signal based on the output feedback signal of the output terminal with higher output power of the two output terminals which is taken as the first output terminal;
obtaining a second feedback signal based on the output feedback signal of the output terminal with smaller output power of the two output terminals which is taken as the second output terminal.

19. The control method for the multi-output switching power supply of claim 18 wherein a sum of the duty cycles of the two output control transistors is 1.

20. The control method for the multi-output switching power supply of claim 16, wherein the multi-output switching power supply comprises three output terminals, and the plurality of output control transistors comprises three output control transistors,
the three output control transistors respectively control the voltage of the three output terminals;
obtains a first feedback signal based on the output feedback signal of the first output terminal of the three output terminals to control the switching state of the main transistor in the power conversion circuit;
the second control module controls the switching state of the three output control transistors based on the output feedback signal of the second output terminal and the output feedback signal of the third output terminal,
wherein, the sum of the duty cycles of the three output control transistors is 1.
